(19) United States
(12) Patent Application Publication
(10) Pub. No.: US 2008/0271307 A1
(43) Pub. Date: Nov. 6, 2008

(54) METHOD OF MANUFACTURING CRYSTAL UNIT

(75) Inventor: Jang Ho PARK, Suwon (KR)

Correspondence Address: LOWE HAUPTMAN HAM & BERNER, LLP, 1700 DIAGONAL ROAD, SUITE 300, ALEXANDRIA, VA, 22314, US

(73) Assignee: SAMSUNG ELECTRO-MECHANICS CO., LTD., Suwon (KR)

(21) Appl. No.: 12/114,368

(22) Filed: May 2, 2008

(30) Foreign Application Priority Data
May 4, 2007 (KR) 10-2007-43738

(51) Int. Cl. H04R 31/00; H01R 43/00

(52) U.S. Cl. 29/594; 29/417; 29/854

(57) ABSTRACT

There is provided a method of manufacturing a crystal unit, the method including: providing a package wafer including a plurality of connecting terminals each having top and bottom ends exposed to top and bottom surfaces of the package wafer; mounting a crystal blank having an excitation electrode formed thereon on at least one of the connecting terminals of the package wafer; depositing and bonding a cap wafer having a cavity with an open bottom therein on the top surface of the package wafer where the crystal blanks are mounted; and cutting bonding portions between the package wafer and the cap wafer into a plurality of individual crystal units. The crystal unit is reduced in thickness and size, and can be manufactured in mass production and packaged in a single process, thereby increasing lead time and process efficiency.

### CROSS-REFERENCE TO RELATED APPLICATIONS

This application claims the priority of Korean Patent Application No. 2007-0043738 filed on May 4, 2007, in the Korean Intellectual Property Office, the disclosure of which is incorporated herein by reference.

### BACKGROUND OF THE INVENTION

1. Field of the Invention

The present invention relates to a method of manufacturing a crystal unit, and more particularly, to a method of manufacturing a crystal unit which is applied to a mobile telecommunication terminal, various kinds of personal mobile communication devices or a small-sized electronic device such as a small game player.

2. Description of the Related Art

In general, a crystal unit, when a voltage is applied thereto from the outside, has a crystal blank oscillated by piezoelectric phenomenon thereof and generates a frequency through the oscillation. This crystal unit acquires a stable frequency and thus is utilized in an oscillating circuit of e.g., a computer and a communication device. Also, this crystal unit, when upgraded to a voltage controlled crystal oscillator (VCXO), a temperature compensated crystal oscillator (TCXO), an oven controlled crystal oscillator (OCXO), enables a frequency to be adjusted more precisely.

Recently, a mobile telecommunication terminal such as a mobile phone has been diversified and complicated in function, accordingly requiring parts thereof to be smaller and thinner. Particularly, a packaging technology needs to be developed to ensure slimness and thinness of a crystal unit, which is a core part in the mobile telecommunication terminal.

### SUMMARY OF THE INVENTION

An aspect of the present invention provides a crystal unit which employs a material such as silicon or glass wafer having a similar thermal expansion coefficient, and can be reduced in thickness and size, manufactured in mass production, and packaged in a single process to increase lead time and process efficiency.

An aspect of the present invention also provides a method of manufacturing a crystal unit in which a frequency of a crystal blank can be adjusted precisely during a packaging process and defects can be inspected accurately.

An aspect of the present invention also provides a method of manufacturing a crystal oscillator in which a wafer is bonded at a low temperature using a low melting point metal to ensure hermetic sealing.

According to an aspect of the present invention, there is provided a method of manufacturing a crystal unit, the method including: providing a package wafer including a plurality of connecting terminals each having top and bottom ends exposed to top and bottom surfaces of the package wafer; mounting a crystal blank having an excitation electrode formed thereon on at least one of the connecting terminals of the package wafer; depositing and bonding a cap wafer having a cavity with an open bottom therein on the top surface of the package wafer where the crystal blanks are mounted; and cutting bonding portions between the package wafer and the cap wafer into a plurality of individual crystal units.

The providing a package wafer may include: forming a pattern mask for terminal connection on the bottom surface of the package wafer; etching the package wafer to form a blind via with a closed top; applying a conductive metal layer on an inner surface of the blind via; and polishing the top surface of the wafer package to expose the top of the blind via.

The applying a conductive metal layer may include filling a conductive filler in the blind via.

The package wafer may be provided on the top surface thereof with a lower pattern for terminal connection disposed on the top end of the internal and external connecting terminal, and the lower pattern for terminal connection is provided on an outer periphery thereof with a bonding pattern bonded to the cap wafer.

The crystal blank mounted on the package wafer may have a frequency adjusted by partially removing the excitation electrode formed on the top surface of the package wafer by dry or ion beam etching.

The cap wafer may have a bonding upper pattern formed uninterruptedly along an outer periphery of the cavity.

The bonding upper pattern may be protectively enclosed by a protective mask before the cavity is formed in the bottom surface of the cap wafer.

The bonding the package wafer and the cap wafer may include thermally bonding the bonding lower pattern formed on the top surface of the package wafer and the bonding upper pattern formed on the bottom surface of the cap wafer together.

The bonding upper and lower patterns may be formed of an uninterrupted pattern surrounding an outer periphery of the crystal blank.

The polishing the top surface of the wafer package may be performed after the cavity is formed.

The polishing the top surface of the wafer package may be performed when the package wafer and the cap wafer are bonded together.

The thermally bonding upper and lower patterns is the step of bonding at a low temperature using a low melting point metal.

### BRIEF DESCRIPTION OF THE DRAWINGS

The above and other aspects, features and other advantages of the present invention will be more clearly understood from the following detailed description taken in conjunction with the accompanying drawings, in which:

FIGS. 1A to 1J sequentially illustrate a process of mounting a crystal blank on a package wafer in a method of manufacturing a crystal unit according to an exemplary embodiment of the invention;

FIGS. 2A to 2D sequentially illustrate a process of forming a cavity in a cap wafer in a method of manufacturing a crystal unit according to an exemplary embodiment of the invention; and

FIGS. 3A to 3C sequentially illustrate a process of bonding a cap wafer to a package wafer in a method of manufacturing a crystal unit according to an exemplary embodiment of the invention.

### DETAILED DESCRIPTION OF THE PREFERRED EMBODIMENT

Exemplary embodiments of the present invention will now be described in detail with reference to the accompanying drawings.

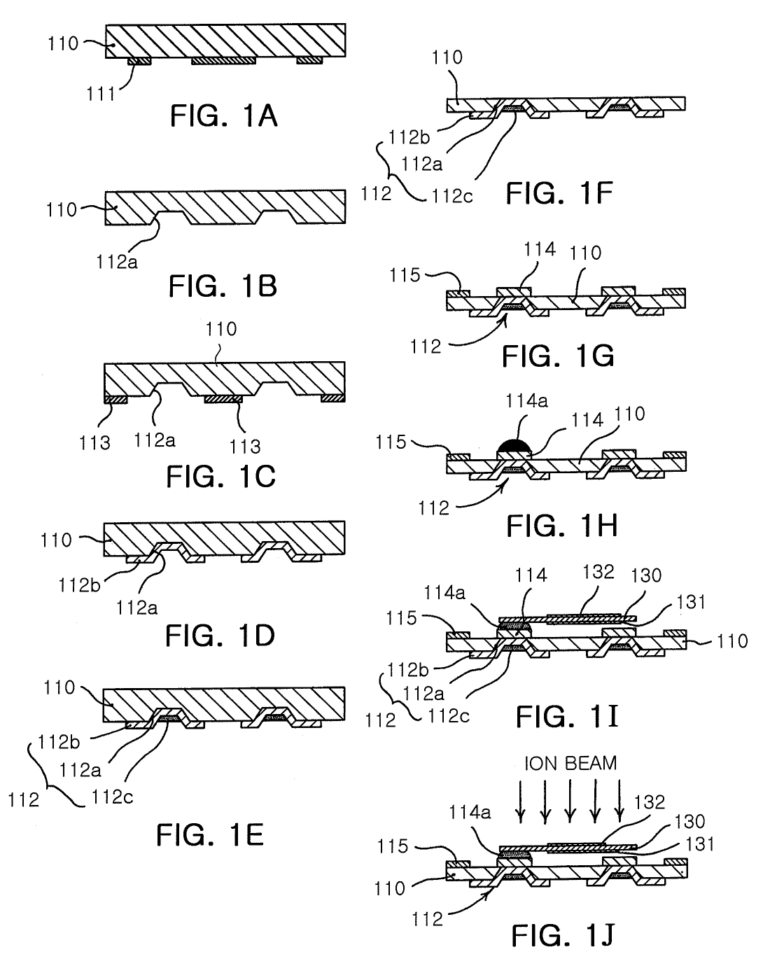

FIGS. 1A to 1J sequentially illustrate a process of mounting a crystal blank on a package wafer in a method of manufacturing a crystal unit according to an exemplary embodiment of the invention.

The package wafer 110 corresponds to a lower substrate of a desired crystal unit. The package wafer 110 is a disc-shaped substrate made of e.g., low-cost glass or silicon.

This package wafer 110 is provided with a plurality of internal and external terminals 112 electrically connected to one end of a crystal blank, which will be described later. Each of the connecting terminals 112 has top and bottom ends exposed to top and bottom surfaces of the package wafer 110, respectively.

As shown in FIG. 1A, to form the connecting terminals 112 on the package wafer 110, a first pattern mask 111 is patterned on the bottom surface of the package wafer 110.

As shown in FIG. 1B, the package wafer 110 is etched by e.g., dry etching such as sand blasting or wet etching. This allows a plurality of blind vias with a closed top and an open bottom to be formed in a predetermined depth in the bottom surface of the package wafer 110.

Here, a portion of the first pattern mask 111 remains on the bottom surface of the package wafer and the remaining portion is removed by ashing.

Subsequently, as shown in FIG. 1C, a second pattern mask 113 is patterned on the bottom of the package wafer 110, excluding the blind via 112a.

Thereafter, as shown in FIG. 1D, a conductive metal is applied on the bottom surface of the package wafer 10 to form a conductive metal layer 112b of a predetermined thickness on an inner surface of the blind via 112a where the second pattern mask 113 is not formed and a portion of the bottom surface of the package wafer 110.

Also, in a case where silicon, i.e., a conductor wafer is utilized as a package wafer, an additional insulating layer made of e.g., SiO₂, and SiN may be applied first prior to applying the conductive metal.

Here, the second pattern mask 113 remaining on the bottom surface of the package wafer 110 after formation of the conductive metal layer 112b is removed by ashing.

Subsequently, as shown in FIG. 1E, the blind via 112ahaving the conductive metal layer 112b applied to a predetermined thickness is filled with a predetermined amount of conductive filler 112c.

The conductive filler 112c may be filled in the blind via 112a in such a way the a bottom surface of the conductive filler is flush with the bottom surface of the package wafer 110, thereby allowing for formation of a step together with the metal layer 112b of the external terminal applied on the bottom surface of the package wafer 110. However, the present embodiment is not limited thereto, and the conductive filler 112c may have the bottom surface flush with the conductive metal layer 112b.

After the conductive metal layer 112b is applied in the blind via 112a or the conductive filler 112c is filled in the blind via 112a, as shown in FIG. 1F, the package wafer 110 has a top surface polished to a predetermined thickness, and accordingly the conductive metal layer 112b is applied in the blind via 112a and also each of the connecting terminals 112 filled with the conductive filler 112c has a top end thereof exposed outward.

Here, the package wafer 110 may be polished until the conductive metal layer 112b formed on the inner surface of the blind via 112a of the internal and external connecting terminal 112 is exposed outward, but not limited thereto. The conductive filler 112c filled inside the blind via 112a, along with the conductive metal layer 112b may be exposed outward.

Thereafter, as shown in FIG. 1G, the package wafer 110 has a terminal connecting pattern 114 formed on the top surface thereof to be disposed on a top end of the internal and external connecting terminal 112. Also, the terminal connecting pattern 114 is provided at an outer periphery thereof with a bonding lower pattern 115 bonded to a cap wafer 120, which will be described later.

The package wafer 110 has an internal connection terminal (not shown) formed on the top surface thereof to be electrically connected to the internal and external connecting terminal having the terminal connecting pattern 114 disposed thereon and electrically connected to the external ground terminal.

The terminal connecting pattern 114, the bonding lower pattern 115 and the internal connection pattern may be formed of a metal material such as Ni and Au and formed on the top surface of the package wafer 110 at the same time.

Also, the bonding lower pattern 115 may be formed of an uninterrupted square-shaped pattern surrounding the terminal connecting pattern 114.

Moreover, as shown in FIG. 1H, the terminal connecting pattern 114 formed on the top end of the internal and external connecting terminal 112 has a bump formed thereon to ensure a sufficient step and a conductive paste 114a is applied thereon.

Subsequently, as shown in FIG. 1I, the crystal blank 130 having excitation electrodes 131 and 132 formed on top and bottom surfaces thereof, respectively has one end fixedly bonded to the conductive paste 114a right above the package wafer 110 and electrically connected to the internal and external connecting terminal 112. The crystal blank 130 has another end formed of a free end.

Meanwhile, the crystal blank 130 electrically mounted on the internal and external connecting terminal 112 of the package wafer 110, as shown in FIG. 1J, has the excitation electrode 131 formed on the top surface thereof exposed outward. Thus, an ion beam is irradiated from right above the crystal blank 130 to remove a portion of the excitation electrode 131 by ion beam etching. This dry etching such as the ion beam etching allows for adjustment of a frequency of the crystal blank 130.

At this time, a power source is applied to the excitation electrode of the crystal blank 120 so that the crystal blank 120 generates oscillation and is adjusted in frequency by virtue of a probe (not shown) disposed below the package wafer 110 to have a front end in contact with the internal and external connecting terminal 112.

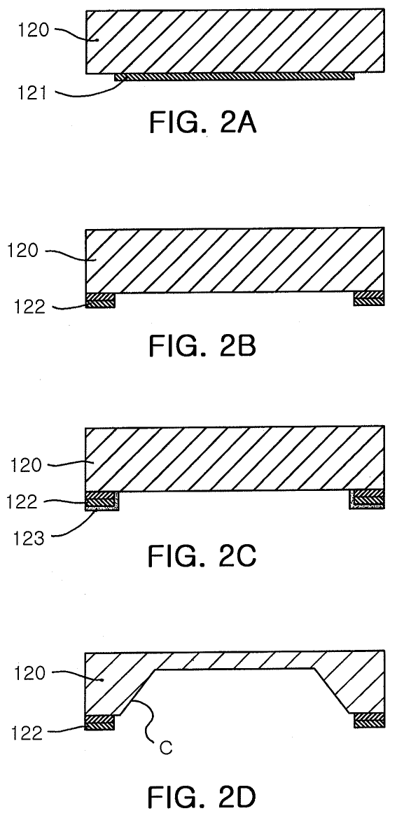

FIGS. 2A to 2D sequentially illustrate a process of forming a cavity in a cap wafer in a method of manufacturing a crystal unit according to an exemplary embodiment of the invention.

The cap wafer 120 corresponds to an upper substrate of a desired crystal unit and is a disc-shaped substrate formed of a low-cost glass or silicon.

This cap wafer 120 has a cavity C formed therein to define a sealed area shielding the crystal blank 130 mounted on the package wafer 110 from external environment when bonded to the package wafer 110. This cavity C is formed in a bottom surface of the cap wafer 120 and has an open bottom.

As shown in FIGS. 4A and 4B, the cap wafer 120 has a third pattern mask 121 patterned on the bottom surface thereof and a bonding top pattern 122 formed on an outer periphery of the third pattern mask 121.

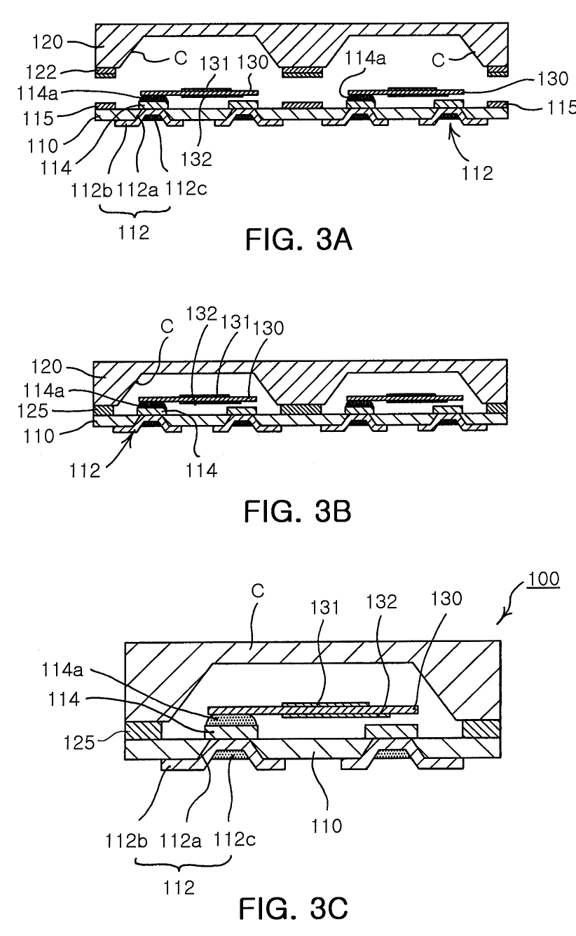

Here, the bonding top pattern 122 is disposed on an area corresponding to a bonding lower pattern 115 (see FIG. 3A) formed on a top surface of the package wafer 110. The package wafer 110 and the cap wafer 120 are bonded together at a low temperature of 300° C. or less by eutectic bonding.

To this end, the bonding lower pattern 115 and the bonding top pattern 122 may be formed of a metal having a low melting point of 300° C. or less when the bonding portion is thermally melted. The bonding top pattern 122 may utilize a low-melting metal material such as Sn and a metal material such as Au or Ni as a metal layer for preventing oxidation.

Also, the third pattern mask 121 remaining on the bottom surface of the cap wafer 120 after the formation of the bonding top pattern 122 is removed by ashing.

Thereafter, to form a cavity C in the bottom surface of the cap wafer 120, as shown in FIG. 2C, a protective mask 123 is formed to protectively surround the bonding upper pattern 122 formed on the bottom surface of the cap wafer 120. Then, as shown in FIG. 2D, the bottom surface of the cap wafer 120 is etched by dry etching such as sand blasting or wet etching to form the cavity C with an open bottom.

The protective mask 123 utilizes a photo resist and a dry film resist, and a metal mask when the pattern has a great width.

Here, the cap wafer 120 having the cavity C formed therein may have the top surface thereof polished to ensure a small thickness.

Also, after forming the cavity C, a portion of the protective mask 123 remaining on the bonding upper pattern 122 is removed by ashing.

FIGS. 3A to 3C sequentially illustrate a process of bonding a cap wafer to a package wafer in a method of manufacturing a crystal unit according to an exemplary embodiment of the invention.

As shown in FIG. 3A, the package wafer 110 and the cap wafer 120 are bonded together when the package wafer 110 having a crystal blank 130 mounted thereon is disposed at a bottom as a lower part and the cap wafer 120 having a cavity C formed therein is disposed at a top as an upper part.

The cavity C formed in the bottom of the cap wafer 120 corresponds to the crystal blank 130 and a bonding upper pattern 122 of the cap wafer 120 opposes a bonding lower pattern 115 of the package wafer 120.

Then, as shown in FIG. 3B, when the cap wafer 120 is deposited on the package wafer 110, the crystal blank is mounted in an area defined between the cavity C of the cap wafer 120 and the package wafer 110, thus allowing the upper and lower patterns 115 and 122 to be in contact with each other. Here, the bonding upper and lower patterns 115 and 122 are formed of an uninterrupted pattern surrounding an outer periphery of the crystal blank 130.

Subsequently, the bonding upper and lower patterns 115 and 122 in contact with each other are provided with a heat source to be melted, thereby integrated into a single bonding metal layer 125. This allows a sealing line to be formed without interruption along the outer periphery of the crystal blank 130, thereby completely shielding the crystal blank 130 from external environment. This also ensures a stable product to be produced even under a high-temperature soldering condition.

In addition, to reduce overall thickness of the package wafer 110 and the cap wafer 120 bonded together by the bonding metal layer 125, the cap wafer 120 has a top surface polished and removed.

Here, the cap wafer 120 has the top surface polished only when the package wafer 110 and the cap wafer 120 are bonded together. The polishing may be performed after forming the cavity C in the bottom surface of the cap wafer 120.

Meanwhile, a sealing portion of the sealing line formed by bonding of the package wafer 110 and the cap wafer 120 can serve as a trimming line to perform cutting. This, as shown in FIG. 3C, will produce a plurality of individual crystal units 100 where the package wafer 110 having the crystal blank 130 mounted thereon is provided as a lower substrate and the cap wafer 120 having a cavity C formed therein is provided as an upper substrate, and a portion between the package wafer 110 and the cap wafer 120 is sealed as an uninterrupted bonding metal layer 125.

As set forth above, according to exemplary embodiments of the invention, cap wafers each having a cavity with an open bottom formed in a top surface of the package wafer whose internal and external connecting terminal has a crystal blank mounted thereon are deposited and bonded together. Then, a sealing portion where the package wafer and the cap wafer are bonded together is cut into a plurality of individual crystal units. This wafer-level packaging process allows a product to be reduced in thickness and size, and saved in manufacturing costs by mass production and can be packaged in a single process to enhance lead time and process efficiency.

In addition, during the packaging process, the crystal blank mounted at a wafer level can be precisely adjusted in a frequency. Also, upper and lower packages can be bonded using a low melting point material such as Sn to ensure high hermetic sealing at a low temperature of 300° C. or less. A smaller and thinner crystal unit can be precisely inspected for detects on the package wafer, thereby significantly enhancing precision and reliability of the product.

While the present invention has been shown and described in connection with the exemplary embodiments, it will be apparent to those skilled in the art that modifications and variations can be made without departing from the spirit and scope of the invention as defined by the appended claims.

What is claimed is:

1. A method of manufacturing a crystal unit, the method comprising:
providing a package wafer comprising a plurality of connecting terminals each having top and bottom ends exposed to top and bottom surfaces of the package wafer;
mounting a crystal blank having an excitation electrode formed thereon on at least one of the connecting terminals of the package wafer;
depositing and bonding a cap wafer having a cavity with an open bottom therein on the top surface of the package wafer where the crystal blanks are mounted; and
cutting bonding portions between the package wafer and the cap wafer into a plurality of individual crystal units.

2. The method of claim 1, wherein the providing a package wafer comprises:
forming a pattern mask for terminal connection on the bottom surface of the package wafer;
etching the package wafer to form a blind via with a closed top;
applying a conductive metal layer on an inner surface of the blind via; and
polishing the top surface of the wafer package to expose the top of the blind via.

3. The method of claim 2, wherein the applying a conductive metal layer comprises filling a conductive filler in the blind via.

4. The method of claim 1, wherein the package wafer is provided on the top surface thereof with a lower pattern for terminal connection disposed on the top end of the internal and external connecting terminal, and the lower pattern for terminal connection is provided on an outer periphery thereof with a bonding pattern bonded to the cap wafer.

5. The method of claim 1, wherein the crystal blank mounted on the package wafer has a frequency adjusted by partially removing the excitation electrode formed on the top surface of the package wafer by dry or ion beam etching.

6. The method of claim 1, wherein the cap wafer has a bonding upper pattern formed uninterruptedly along an outer periphery of the cavity.

7. The method of claim 6, wherein the bonding upper pattern is protectively enclosed by a protective mask before the cavity is formed in the bottom surface of the cap wafer.

8. The method of claim 1, wherein the bonding the package wafer and the cap wafer comprises thermally bonding the bonding lower pattern formed on the top surface of the package wafer and the bonding upper pattern formed on the bottom surface of the cap wafer together.

9. The method of claim 8, wherein the bonding upper and lower patterns are formed of an uninterrupted pattern surrounding an outer periphery of the crystal blank.

10. The method of claim 2, wherein the polishing the top surface of the wafer package is performed after the cavity is formed.

11. The method of claim 2, wherein the polishing the top surface of the wafer package is performed when the package wafer and the cap wafer are bonded together.

12. The method of claim 8, wherein the thermally bonding upper and lower patterns is the step of bonding at a low temperature using a low melting point metal.
